(19) United States
(12) Patent Application Publication
(10) Pub. No.: US 2010/0125790 A1
(43) Pub. Date: May 20, 2010

(54) METHOD, SYSTEM AND PROGRAM FOR INTERACTIVE ASSEMBLY OF A PRODUCT

(75) Inventor: Gregory L. ERSKIN, Ocala, FL (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation, Bethesda, MD (US)

(21) Appl. No.: 12/272,576

(22) Filed: Nov. 17, 2008

(51) Int. Cl. G06F 3/048

(52) U.S. Cl. 715/709

(57) ABSTRACT

A method for assembly of a product includes displaying an image of a product to be assembled on a presentation apparatus. The method includes superposing a first instruction for assembly of the product on the image of the product displayed on the presentation apparatus, and superposing a second instruction for assembly of the product on the image of the product displayed on the presentation apparatus, upon receipt of an input to the presentation apparatus that the first instruction was completed. A computer-readable recording medium having a computer program recorded thereon and a presentation apparatus for assembly of a product are also provided.

### FIELD OF THE DISCLOSURE

The present disclosure relates to a method, system and computer program recorded on a computer-readable recording medium for facilitating assembly of a product using, for example, interactive, dynamic and intuitive presentations for each sequence of the product assembly.

### BACKGROUND

When an individual tasked with assembling a product is provided with a set of instructions, the instructions can include both a graphical representation of the product to be assembled and textual commands for assembling the product. The graphical and textual instructions may be provided in separate documents that each statically describe the steps to be performed to assemble the product. Alternatively, if the instructions are provided in a computer-readable format, the graphical and textual instructions may be provided in separate display windows respectively displaying the graphical and textual instructions statically. Both of these scenarios involve the assembler toggling back and forth between the textual commands and the graphical representation of the product, which can be cumbersome for the assembler and lead to interpretative variations or skipping one or more sequential steps in the assembly of the product as the assembler is toggling back and forth between the separate textual and graphical instructions. In addition, the separate presentation of graphical and textual instructions can amount to an inefficient duplication of the information presented.

A graphical representation of a product to be assembled has been combined with textual commands in the same presentation medium. For example, graphical and textual instructions can be combined in a static presentation provided on paper or in a display window of a computer program. While the combination of graphical and textual instructions may obviate the need to toggle between different documents or display windows, the separate presentation of graphical and textual instructions and the combined presentation of graphical and textual presentations are static and not intuitive for the assembler, can lead to an inefficient amount of duplication, and can lead to one or more sequential steps in the assembly of the product being skipped.

Video presentations have also been used to illustrate the assembly of a product. However, video presentations involve the assembler viewing a predetermined portion of the video and committing the instructions to memory, and then pausing or stopping the video presentation before returning to assemble the product by memory. In addition, video presentations pose storage and bandwidth considerations, and any modifications to the product or the instructions for its assembly involve editing of the video presentation or production of a new video presentation.

U.S. Pat. No. 6,750,884 to Steigerwald et al. discloses an apparatus for presenting a series of pre-configured instruction screen displays to a user according to a predetermined sequence. One pre-configured instruction screen display is presented at a time, until the apparatus receives a user-initiated instruction to display the next pre-configured instruction screen. Each pre-configured instruction screen display includes text information describing the work to be done during the instruction, and graphical information graphically illustrating the work to be done during the instruction. The graphical information includes a pictorial representation of a machine to be worked on and other indicia such as movement indicia indicating a direction of movement of a part or tool, and highlight indicia highlighting a pertinent part or tool in the instruction. Each pre-configured instruction screen display is statically displayed as a collective document on the display, such that an individual instruction screen display including both the text and graphical information is generated for each instruction. Changes to the text or graphical information between two pre-configured instruction screen displays involves generation of a different pre-configured instruction screen display consisting of a different combination of text and graphical information.

### SUMMARY OF THE DISCLOSURE

An exemplary embodiment disclosed herein provides a method for assembly of a product. The method includes displaying an image of a product to be assembled on a presentation apparatus. The method includes superposing a first instruction for assembly of the product on the image of the product displayed on the presentation apparatus. In addition, the method includes superposing a second instruction for assembly of the product on the image of the product displayed on the presentation apparatus, upon receipt of an input to the presentation apparatus that the first instruction was completed.

Another exemplary embodiment provides a computer-readable recording medium having a computer program recorded thereon for causing a processor of a presentation apparatus communicatively coupled to the computer-readable recording medium to perform operations of displaying an image of a product to be assembled on a presentation apparatus, superposing a first instruction for assembly of the product on the image of the product displayed on the presentation apparatus, and superposing a second instruction for assembly of the product on the image of the product displayed on the presentation apparatus, upon receipt of an input to the presentation apparatus that the first instruction was completed.

An exemplary presentation apparatus disclosed herein includes a display, and a processor configured to instruct the display to display an image of a product to be assembled, and display a plurality of instructions for assembly of the product. The exemplary presentation apparatus also includes an input device configured to receive an input indicating completion of an instruction displayed on the display. The processor of the exemplary presentation apparatus is configured to instruct the display to display the image of the product. The processor is also configured to superpose a first instruction for assembly of the product and instruct the display to display the superposed first instruction on the displayed image of the product. In addition, the processor of the exemplary presentation apparatus is configured to superpose a second instruction for assembly of the product and instruct the display to display the superposed second instruction on the displayed image of the product, upon the input device receiving an input indicating that the first instruction was completed.

### BRIEF DESCRIPTION OF THE DRAWING FIGURES

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a flowchart illustrating an exemplary method of assembly of a product according to at least one embodiment;

FIGS. 2A-2D illustrate an illustrative example of an exemplary method of assembly of a product;

FIG. 3 is a flowchart illustrating another exemplary embodiment of assembly of a product according to at least one embodiment;

FIGS. 4A and 4B illustrate another illustrative example of an exemplary method of facilitating assembly of a product;

FIG. 5 is an illustrative example of a graphical instruction enabling selection of the illustrated components;

FIG. 6 is an illustrative example of an index display; and

FIG. 7 is an explanatory diagram illustrating constituent elements of a presentation apparatus according to an exemplary embodiment.

### DETAILED DESCRIPTION OF EXEMPLARY EMBODIMENTS

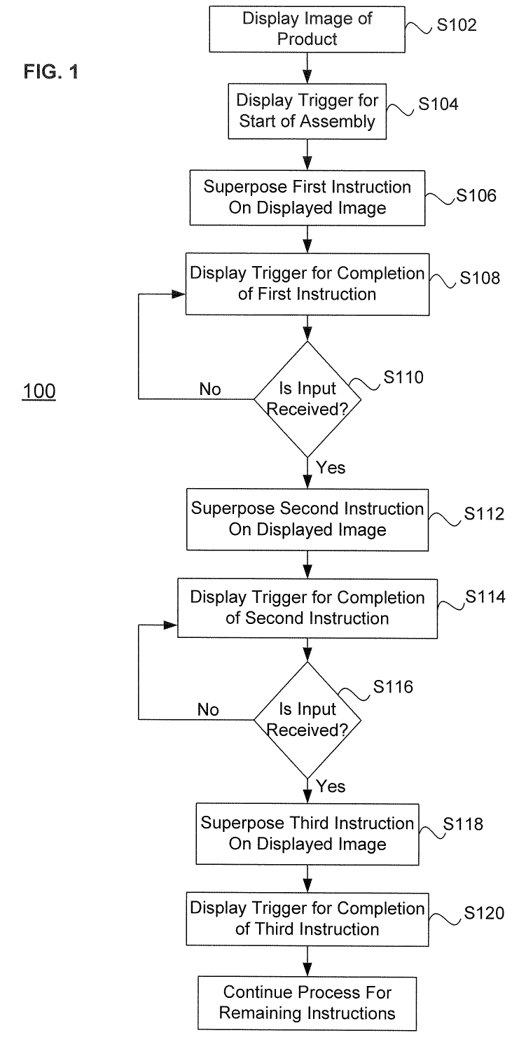

FIG. 1 is a flowchart diagram illustrating an exemplary method 100 of facilitating assembly of a product. The exemplary method provides an interactive, dynamic and intuitive explanation for completing each instruction in the assembly of a product.

As shown in FIG. 1, step S102 includes displaying an image of a product to be assembled on a presentation apparatus. As used herein, a presentation apparatus can encompass any electronic device having a display comprised therein or a display communicatively coupled thereto, a processor to perform the constituent functions described herein, and an input device to receive inputs from an assembler of the product. As used herein, the term “communicatively coupled” means an electrical connection, whether by wired or wireless transmission mediums. For ease of illustration, the case where a display is comprised in the presentation apparatus, and the case where a display is communicatively coupled to the presentation apparatus may be generically described as the “display of the presentation apparatus.” It is to be understood, however, that the present disclosure encompasses both configurations. The term “assembler” means an individual performing the assembly of a product, including another individual assisting the individual performing the assembly of the product.

For example, a presentation apparatus can be a computer, such as a laptop, desktop, workstation, server computer or gaming computer, a personal digital assistant (PDA), a mobile telephone, a smartphone, a digital versatile disc (DVD) player, a high-definition DVD player (e.g., a Blu-ray player), etc., or any combination of these devices. An exemplary presentation apparatus will be described hereinbelow.

The image of the product to be assembled can be an illustration of the product or a part of the product at any stage in the assembly of the product. For example, the image can be a photograph or drawing indicating the product at an initial stage of assembly, at the completion of assembly, or at any point therebetween. The image displayed on the display of the presentation apparatus can be a photographic image taken of the product, an ink or computer-generated drawing of the product, or any other illustrative representation of the entire product or a part of the product to be assembled. For ease of illustration, the image of the product or the image of part of the product may generically be described hereinafter as “the image of the product.” However, it is to be understood that the phrase “the image of the product” can encompass only part of the product to be assembled.

The image of the product to be assembled can remain the same throughout each instruction in the assembly of the product. In the case where the display and/or processor of the presentation apparatus is configured to refresh the frame rate of pixels displayed on the display or refresh the entirety of the visual illustration displayed on the screen of the display at predetermined intervals, the image will remain the same upon each frame or screen refresh. Accordingly, the image of the product displayed on the presentation apparatus can be constituted by the same representation of the product (or part of the product) for each instruction display.

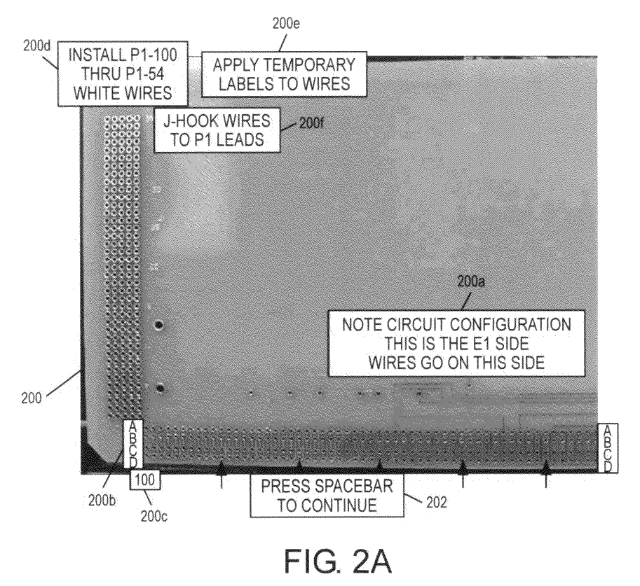

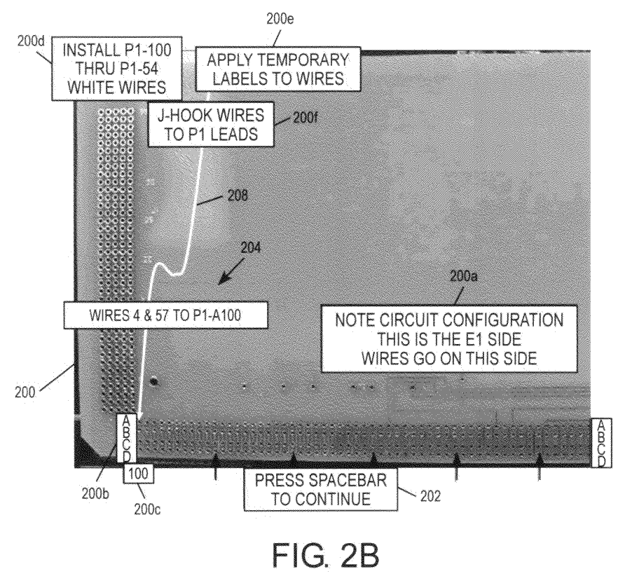

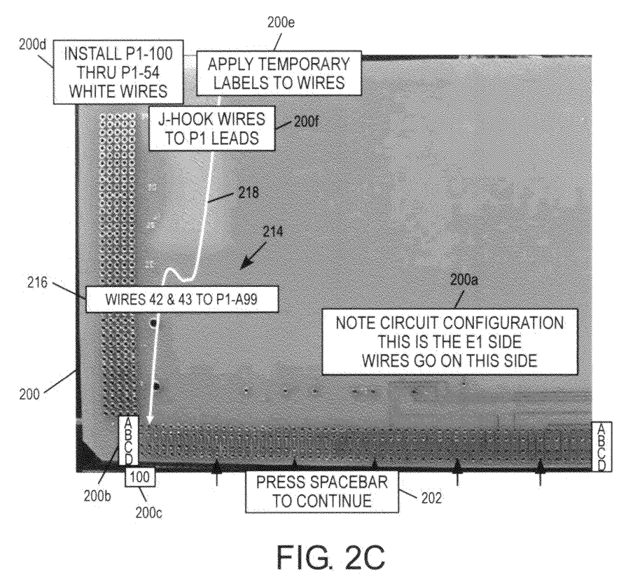

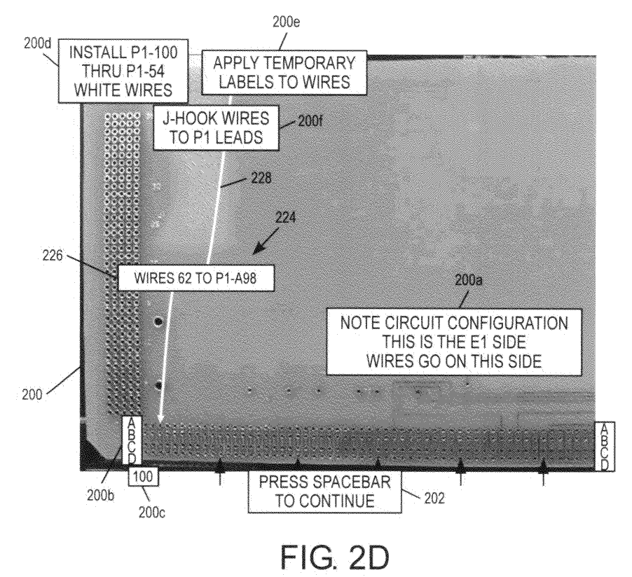

For example, FIG. 2A illustrates an image 200 of a product to be assembled. In the example of FIG. 2A, the image 200 represents a photographic image of a circuit board on which wires are to be connected at predetermined points of connection in the circuit board. The circuit board illustrated in FIG. 2A can represent the product to be assembled, or the circuit board can represent a part of a product to be assembled.

In the example of FIG. 2A, textual information boxes 200a-200f are superposed on the image 200 of the product. The textual information boxes 200a-200f can indicate general information and/or assembly tips that are pertinent during one or more sequences in the assembly of the product or throughout the assembly of the product. For example, textual information box 200a identifies the orientation of the circuit board and the side of the circuit board on which the wires are to be connected. Textual information boxes 200b and 200c identify axis labels of the connection points on the circuit board to guide the assembler in the recognition of the various connection points during assembly. Textual information box 200d identifies tasks associated with the assembly of the product. For example, during the course of assembly, the assembler is to install “P1-100 thru P1-54 white wires,” where P represents a “connection point” (e.g., pin) and the number following the letter “P” represents the number of the connection point (e.g., electrical lead). Textual information box 200e identifies an assembly tip to apply temporary labels to the wires, to aid in the assembler's recognition of the various wires used in the assembly process. Textual information box 200f identifies an assembly tip of j-hooking the wires to obtain a proper connection with the connection points on the circuit board. As known in the art, a j-hook is an attachment technique, followed by soldering, for example, for a permanent electrical and mechanical attachment to a circuit board.

Such textual information boxes 200a-200f can be superposed on the image 200 of the product throughout each instruction in the assembly of the product, or can be removed from the image displayed on the presentation apparatus at any predetermined point in the assembly process, such as after the completion of the first instruction, for example. The textual information boxes 200a-200f can be superposed individually or in groups in any predetermined order on the image 200. The textual information boxes 200a-200f can also be displayed in areas of the screen of the display outside the displayed image of the product. For example, one or more of the textual information boxes 200a-200f can be displayed in areas of the display bordering the representation of the image 200 of the product on the display of the presentation apparatus. In the examples of FIGS. 2A-2D, the textual information boxes 200a-200f are superposed on the display prior to the first instruction and are maintained throughout the presentation of each instruction.

Step S104 in FIG. 1 includes displaying a trigger 202 to request an input by the assembler to start the assembly process. As used herein, a “trigger” is a visual and/or audible indication displayed on or outputted from the presentation apparatus to indicate to the assembler that action is required to begin the assembly of the product or indicate completion of an instruction in order to advance to the next instruction in the assembly of the product. For example, a trigger can be displayed on the display of the presentation apparatus concurrently with the image 200 of the product to be assembled. A trigger can also be an audible output generated by an audio output device (e.g., speaker and sound card) of the presentation apparatus to indicate to the assembler that the assembler must perform a predetermined operation to begin assembly of the product or indicate completion of an instruction in order to advance to the next sequence in the assembly of the product.

In the examples of FIGS. 2A-2D, the trigger 202 is displayed as a text box concurrently with the image 200 of the product to be assembled. In the examples of FIGS. 2A-2D, the trigger 202 indicates “press spacebar to continue.” Accordingly, in the examples of FIGS. 2A-2D, the operation required by the assembler to begin assembly or indicate completion of an instruction in the assembly of the product is the assembler pressing the spacebar key on a computer, if the computer functions as the presentation apparatus in the examples of FIGS. 2A-2D. As described above, a presentation apparatus can be, for example, a computer, a personal digital assistant (PDA), a mobile telephone, a smartphone, a television, a DVD player, a high-definition audio/video player (e.g., Blu-ray player), etc. Accordingly, any input key or remote input key (e.g., remote control for a DVD player) can be designated as a key on which the assembler provides an input to receive the first instruction or indicate completion of an instruction in order to receive the next instruction in the assembly of the product. For example, if the presentation apparatus is a computer, PDA or smartphone, any QWERTY key of a keyboard can be designated as the input device to receive the first or subsequent instruction. In addition, if the presentation apparatus is a computer, any input device comprised in the computer or connected thereto (e.g., mouse, barcode reader, etc.) can be configured to receive the first or subsequent instruction, as well as the input by the assembler to initiate the assembly presentation. The display of the presentation apparatus can also be configured with touchscreen functionality and/or graphics tablet functionality in which the assembler can provide an input on a predetermined portion of the display, and a processor of the presentation apparatus recognizes the input.

The exemplary embodiments disclosed herein also provide for the assembler providing an audio input via an audio input device (e.g., microphone and sound card) to the presentation apparatus. In this case, the presentation apparatus can include voice recognition hardware and software to recognize a predetermined word or phrase that constitutes a predetermined or programmed input to begin the assembly of the product or indicate completion of an instruction in the assembly of the product. For example, a presentation apparatus having voice recognition functionality can be programmed to intelligently recognize the word “start” spoken by the assembler to initiate presentation of the first instruction in the assembly of the product and intelligently recognize the word “next” spoken by the assembler as an indication by the assembler that the current instruction has been completed so that the next instruction will be displayed.

In either case of a manual or audio input by the assembler, the trigger 202 can be displayed on the display concurrently with the image 200 of the product. Such display of the trigger 202 provides interactivity with the assembler, because the assembler is invited to submit a predetermined input to begin the assembly process or indicate completion of a particular instruction. The same trigger 202 can be displayed throughout each instruction such as in the examples of FIGS. 2A-2D. Alternatively, different manifestations of triggers 202 can be employed for different instructions. The interactivity of the assembly process greatly enhances the assembler's ability to maintain attention on the current instruction being presented to the assembler, and thereby assist comprehension of the instruction at hand.

Step S106 in FIG. 1 includes superposing a first instruction for assembly of the product on the image 200 of the product that is displayed on the presentation apparatus. Each instruction superposed on the image 200 of the product is displayed on a display device comprised in or communicatively coupled to the presentation apparatus.

For example, with reference to FIG. 2B, a first instruction 204 is superposed on the image 200 of the product that is displayed on the presentation apparatus. Each instruction includes a graphical depiction and a textual depiction of a part of the product to be assembled in the respective instruction. For example, as illustrated in FIG. 2B, the first instruction 204 includes a textual depiction 206 and a graphical depiction 208.

The textual depiction 206 includes a textual command or description identifying the process to be completed during the completion of the first instruction 204. For example, the textual depiction 206 can provide a description of the part of the product to be assembled and/or a command for completing assembly of the part of the product illustrated in the first instruction 204.

The graphical depiction 208 includes a visual representation of the part of the product to be assembled. For example, the graphical depiction 208 in the example of FIG. 2B can be an animated depiction of the placement of the wire to connection point A100. Upon receiving the input by the assembler (e.g., pressing the spacebar on a keyboard), the wire is illustrated animatedly by first appearing at the top of the image 200 (e.g., at the border of the image 200 abutting the placement of the textual information box 200e) and then progressing (e.g., with a drawing motion) toward the illustrated end connection placement of the wire (see arrow) at connection point A100. The animated representation of the placement of the part illustrated in the graphical depiction 208 provides an intuitive and dynamic presentation that captures and maintains the assembler's attention throughout the animated depiction of the part of the product to be assembled. Any of a variety of animation actions such as enter, exit, emphasis and motion actions can be used to illustrate the textual descriptions (which can “fly in” to the image) and/or the graphical depictions (which can have the appearance of being drawn and/or moved within the visual representation). Emphasis can be achieved for example, using different colors, flashing, spinning, intensity variation and so forth to highlight a particular assembly operation at a given time.

The graphical depiction 208 and any subsequent graphical depiction as described hereinafter can be presented as an animated depiction that illustrates how a part of the product (e.g., the wire to be connected to connection point A100 in FIG. 2B) is to be assembled in the respective instruction. The graphical depiction 208, including an animated presentation thereof, is correlated with the textual depiction 206, as shown in the example of FIG. 2B. The correlated textual and graphical depictions 206, 208 of the first instruction 204 as shown in FIG. 2B illustrate to the assembler how the part of the product is to be assembled. The textual and graphical depictions of each instruction can be presented concurrently, or either the textual or graphical depiction can be presented one after the other on the display of the presentation apparatus.

The exemplary embodiments disclosed herein also provide that at least one instruction can be an audible instruction output from the presentation apparatus audibly explaining the respective instruction in the assembly of the product. For example, in the example of FIG. 2B, the first instruction 204 can include, as an addition and/or a substitute for the textual depiction 206 or as a confirmation of the textual depiction 206 superposed on the image 200 of the product, an audible explanation of how the part of the product pertaining to the first instruction 204 is to be assembled.

Step S108 in FIG. 1 includes displaying a trigger 202 for completion of the first instruction 204. The trigger 202 illustrated in FIG. 2B can be displayed concurrently with the presentation of the first instruction 204, before the presentation of the first instruction 204, or after the presentation of the first instruction 204. Each trigger presented on the presentation apparatus for a respective one of the instructions can remain visible until, for example, the assembler has provided the requested input to indicate completion of the instruction. Alternatively, the triggers can disappear after a predetermined period of time (e.g., 30 seconds after the corresponding instruction was presented) and then reappear after another predetermined period of time (e.g., 30 seconds after the trigger disappeared from view) to prevent the assembler from prematurely activating the trigger to indicate completion of the respective instruction.

Step S110 in FIG. 1 includes determining whether an input from the assembler has been received by the presentation apparatus. The input to the presentation apparatus is initiated by the assembler of the product. The assembler input can include at least one of a manual input to an input device of the presentation apparatus, and an audible input to an audio input device of the presentation apparatus. Accordingly, the assembler's input can be in the form of a manual input (e.g., physically depressing a predetermined key that is configured to accept the input from the assembler), and/or an audible input that is recognized by the presentation apparatus.

The determination of whether the assembler input has been received is performed by the processor of the presentation apparatus in conjunction with hardware components of the presentation apparatus and/or software components recorded on a recording medium of the presentation apparatus that are configured to receive the assembler's input. For example, if the presentation apparatus is a computer, the processor of the computer can recognize that the spacebar has been pressed, in accordance with the example of FIG. 2B where the spacebar is designated as the input key.

If the input has not been received by the assembler, the first instruction 204 continues to be superimposed on the image 200 of the product to be assembled. In addition, the trigger 202 can continue to be presented until the assembler's input has been received, or the trigger 202 can disappear and reappear according to the predetermined display intervals as described above.

Step S112 in FIG. 1 includes superposing a second instruction 214 for assembly of the product on the image 200 of the product that is displayed on the presentation apparatus, upon receipt of the input to the presentation apparatus that the first instruction 204 was completed. For example, as illustrated in FIGS. 2B and 2C, once the assembler provides the input to the presentation apparatus in accordance with the displayed trigger 202, the second instruction 214 illustrated in FIG. 2C is superposed on the image 200 of the product to be assembled.

Similar to the first instruction 204 illustrated in FIG. 2B, the second instruction 214 illustrated in FIG. 2C includes a textual depiction 216 and a graphical depiction 218. The textual depiction 216 includes a textual command or description identifying the process to be completed during the completion of the second instruction 214. For example, as illustrated in FIG. 2C, the textual depiction 216 provides a description of the part of the product to be assembled as well as a command for completing assembly of the part of the product illustrated in the second instruction 214.

The graphical depiction 218 includes a visual representation of the part of the product to be assembled. The graphical depiction 218 can be animatedly superimposed on the image 200 of the product to illustrate the connection of wires 42 and 43 to connection point A99. For example, in FIG. 2C, the presentation of the wires includes animatedly presenting the wire to first appear at the top of the image 200 (e.g., at the border of the image 200 abutting the placement of the textual information box 200e) and then animatedly progressing the presentation of the wire toward the illustrated placement of the wire (see arrow) at the connection point A99. The animated presentation of the placement of the wire provides an intuitive and dynamic presentation that captures and maintains the assembler's attention throughout the graphical depiction 218 of the part of the product to be assembled.

Similar to the first instruction 204, the textual and graphical depictions 216, 218 of the second instruction 214 are correlated to graphically illustrate the part of the product to be assembled and provide textual instructions on assembling the part of the product.

Step S114 in FIG. 1 includes displaying a trigger 202 for completion of the second instruction 214. Similar to the trigger 202 illustrated in FIG. 2B, the trigger 202 illustrated in FIG. 2C can be displayed concurrently with the presentation of the second instruction 214, before the presentation of the second instruction 214, or after the presentation of the second instruction 214. In addition, the trigger 202 illustrated in FIG. 2C can remain visible until the assembler has provided the requested input to the presentation apparatus, or the trigger can intermittently disappear and reappear in predetermined intervals to prevent the assembler from prematurely activating the trigger to indicate completion of the respective instruction.

Step 116 in FIG. 1 includes determining whether an input from the assembler has been received by the presentation apparatus. As described above with respect to FIG. 2B, the input can be in the form of a manual and/or audible input, and the input is recognized by the presentation apparatus. If the input has not been received, the second instruction 214 continues to be superimposed on the image 200 of the product to be assembled. In addition, the trigger 202 can continue to be presented until the assembler's input has been received, or the trigger 202 can disappear and reappear according to the predetermined display intervals as described above.

Step S118 in FIG. 1 includes superposing a third instruction 224 for assembly of the product on the image 200 of the product that is displayed on the presentation apparatus, upon receipt of the input to the presentation apparatus that the second instruction 214 was completed. For example, as illustrated in FIG. 2D, once the assembler provides the input to the presentation apparatus in accordance with the displayed trigger 202, the second instruction 224 illustrated in FIG. 2D is superposed on the image 200 of the product to be assembled.

Similar to the first and second instructions 204, 214, the third instruction 224 illustrated in FIG. 2D includes a textual depiction 226 and a graphical depiction 228. The textual depiction 226 includes a textual command or description identifying the process to be completed during the completion of the third instruction 224. For example, as illustrated in FIG. 2D, the textual depiction 226 provides a description of the part of the product to be assembled as well as a command for completing assembly of the part of the product illustrated in the third instruction 224. The graphical depiction 228 can include an animated depiction for illustrating how the part of the product illustrated in the third instruction 224 is to be assembled, similar to the above descriptions of the graphical depictions 208, 218 of the first and second instructions 204, 214, respectively. The textual and graphical depictions 226, 228 of the third instruction 228 are correlated to graphically illustrate the part of the product to be assembled and provide textual instructions on the assembling the part of the product.

Step S120 in FIG. 1 includes displaying a trigger 202 for completion of the third instruction. Similar to the triggers 202 illustrated in FIGS. 2B and 2C, the trigger 202 illustrated in FIG. 2D can be displayed concurrently with the presentation of the third instruction 224, before the presentation of the third instruction 224, or after the presentation of the third instruction 224. In addition, the trigger 202 illustrated in FIG. 2D can remain visible until the assembler has provided the requested input to the presentation apparatus, or the trigger 202 can intermittently disappear and reappear in the predetermined display intervals as described above.

As shown in FIG. 1, the process of superposing an instruction on the image 200 of the product and displaying a trigger is continued for each subsequent instruction. The designer of the assembly process can use as many separate instructions as is deemed appropriate for facilitating assembly of a given product. Each instruction and trigger captures and maintains the attention of the assembler and provides a virtual “checklist” for completing each instruction in the assembly of the product. Such an interactive, visual, dynamic and intuitive assembly presentation technique permits the designer of the assembly process to consider how the assembler is to complete each instruction, and apportion the assembly process into as many assembly instructions that are deemed to provide an intuitive and easy to understand assembly of a product. In addition, the instruction presentation process of the exemplary embodiments can advantageously reduce the number of assembly errors associated with static presentations of textual and graphical instructions, and the number of assembly errors associated with video presentations that involve the assembler viewing a predetermined portion of the video, committing the instructions to memory and then pausing or stopping the video to return to the assembly of the product.

Moreover, the instruction presentation process of the exemplary embodiments obviates the generation of different pre-configured instruction screen displays for each instruction, as disclosed in the Steigerwald patent, in which each pre-configured instruction screen display involves the generation of different screen displays each consisting of a different combination of text and graphical information for each instruction.

The exemplary first through third instructions 204, 214, 224 were described above as having an animated depiction for their respective graphical depictions 208, 218, 228. The exemplary embodiments of the present disclosure are not limited to such an animated depiction. For example, the graphical depiction of any instruction can include color highlighting depictions in which the part of the product to be assembled is highlighted by a predetermined color to attract the attention of the assembler. In addition, the graphical depiction of any instruction can include graduated intensity representations of the part of the product illustrated in the respective instruction to give the appearance that the part of the product is originating from the image 200 of the product that is displayed on the presentation apparatus. The graphical depictions of each instruction can be represented by any other or combination of suitable presentation techniques that attract the attention of the assembler.

In the examples of FIGS. 2B-2D described above, if the input from the assembler has been received to indicate completion of the presently superimposed instruction, the processor of the presentation apparatus can be configured to cause the presently superimposed instruction to be removed. Accordingly, in the example of FIG. 2B, upon receiving the assembler input, the processor of the presentation apparatus causes the first instruction 204 superposed on the image 200 of the product to be removed. Prior to removing the first instruction 204, a confirmation dialog box can be displayed concurrently with the first instruction 204 to request the assembler to confirm that he or she has indeed completed the first instruction 204.

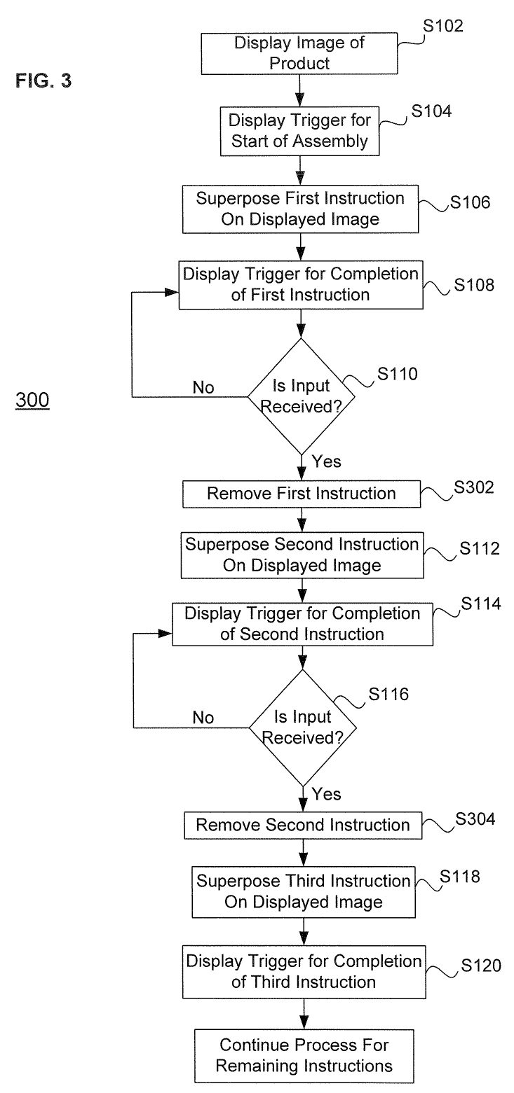

The additional removal processes of the exemplary embodiments are illustrated in FIG. 3, in which like elements of FIG. 1 are denoted by like reference numerals. For instance, after there has been a positive determination by the processor that the assembler input has been received to indicate completion of the first instruction 204, the first instruction is removed 204 (step S302 in FIG. 3). In the examples of FIGS. 2B and 2C, the superposition of the second instruction 214 occurs after the first instruction 204 has been removed. In addition, step S304 in FIG. 3 includes removing the second instruction 214 upon receiving the assembler input that the second instruction 204 was completed. Accordingly, if the instruction has been received by the assembler to indicate completion of the second instruction 214, the second instruction 214 is removed, and the third instruction 224 is thereafter superimposed on the image 200 of the product to be assembled.

Accordingly, the instruction presentation process can include removing an instruction superposed on the image 200 of the product upon receipt of the input to the presentation apparatus to advance to an instruction immediately subsequent to the superposed instruction. The removal of each instruction is initiated upon the assembler providing the input to the presentation apparatus to indicate that the superposed instruction was completed.

The removal of an instruction that is presently superimposed on the image 200 of the product to be assembled can intuitively assist the assembler to interactively comprehend the current instruction and not be distracted with information not pertinent to the current instruction. Such concentrated instruction presentations can therefore capture and maintain the attention of the assembler on only the current instruction.

The present disclosure is, however, not limited to such a configuration in which the presently superimposed instruction is removed upon receipt of the assembler input that the presently superimposed instruction has been completed. Exemplary embodiments of the present disclosure provide that one or more sequential instructions can be displayed concurrently to illustrate a cumulative depiction of the product to be assembled according to the most recent instruction superposed on the image 200 of the product.

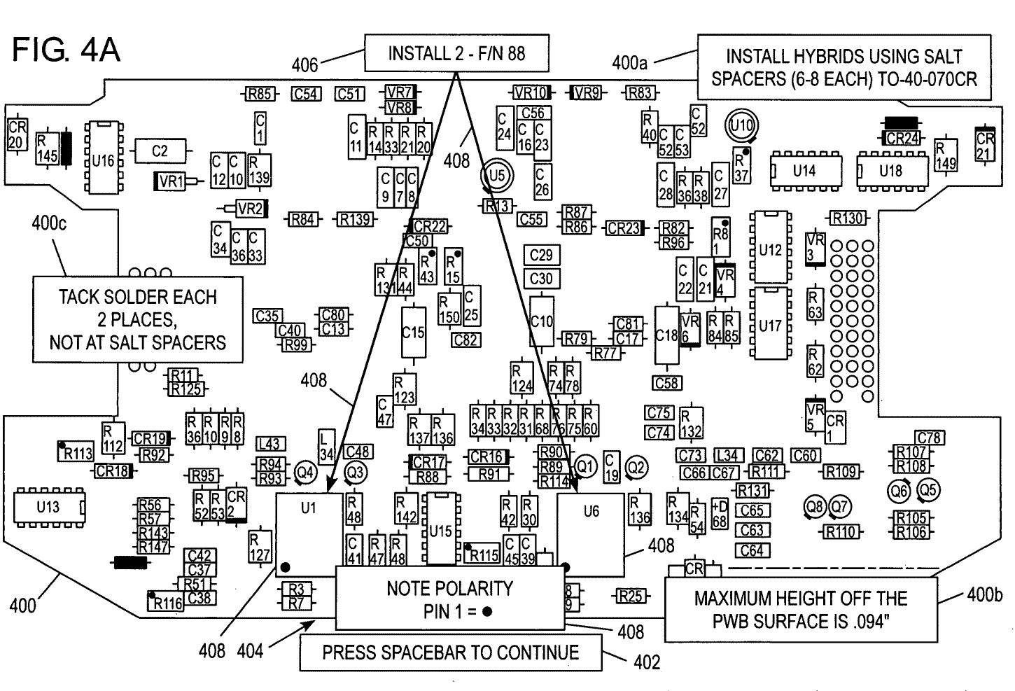

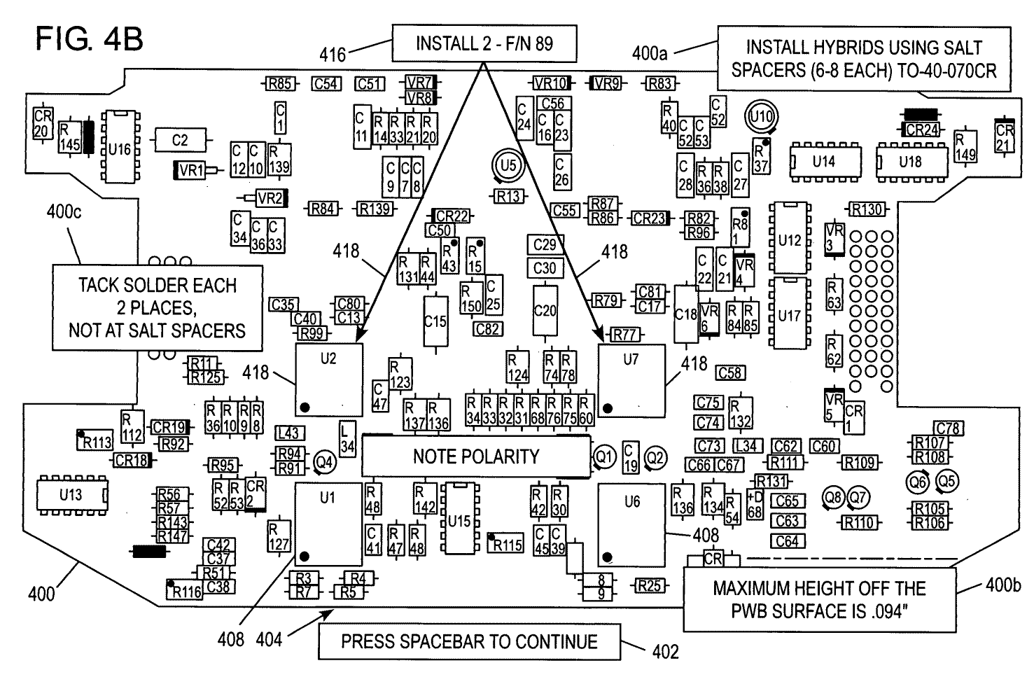

FIGS. 4A and 4B illustrate an exemplary embodiment in which each instruction includes a cumulative depiction of the product to be assembled according to the respective instruction in the assembly of the product.

For instance, FIGS. 4A and 4B illustrate an image 400 of a product to be assembled. In the examples of FIGS. 4A and 4B, the image 400 is a schematic drawing of a circuit board on which hybrid circuits are to be installed. Textual information boxes 400a-400c are displayed in the examples of FIGS. 4A and 4B to provide guidance to the assembler in completing the instructions. Respective triggers displayed on the display of the presentation apparatus are denoted with reference numeral 402 in FIGS. 4A and 4B.

FIG. 4A illustrates that a first instruction 404 superposed on the image 400 includes a textual depiction 406 and a graphical depiction 408. The graphical depiction 408 includes arrows denoting the placement of the circuit boards, along with a pictorial representation of the circuit boards. In addition, the graphical depiction 408 includes a hovering information box of “Note Polarity . . . ” to capture the assembler's attention as to the proper orientation of the hybrids. Similar to the graphical depictions illustrated in FIGS. 2B-2D, the graphical depictions 408 can include an animated depiction and/or any other suitable representation format for informing the assembler of the process to complete the superposed instruction 404.

Upon receiving the assembler's input to indicate completion of the first instruction 404, a second instruction 414 is then superposed on the image 400 of the product to illustrate the cumulative depiction of the product to be assembled according to the first and second instructions 404, 414.

FIG. 4B illustrates that the second instruction 414 includes a textual depiction 416 and a graphical depiction 418. The graphical depiction 418 of the second instruction 414 includes a pictorial representation of the circuit boards to be installed in the second instruction 414, as well as a pictorial representation of the circuit boards that were installed in the first instruction 404. In particular, in the example of FIG. 4B, reference numerals 408 identify pictorial representations of the circuit boards installed in the first instruction 404 (e.g, circuit boards U1 and U6), and reference numerals 418 identify pictorial representations of the circuit boards to be installed in the second instruction 414 (e.g., circuit boards U2 and U7). In addition, the graphical depiction 418 of the second instruction 414 also includes a hovering information box proximate to circuit boards U2 and U7. Note that the placement of the hovering information boxes in the examples of FIGS. 4A and 4B are proximately related to the part of the product to be assembled in the respective instruction.

Accordingly, exemplary embodiments of the present disclosure provide that the cumulative depiction of each instruction subsequent to the first instruction in the assembly of the product illustrates completion of each previous instruction in the assembly of the product. In the examples of FIGS. 4A and 4B, the cumulative depiction of each instruction is represented by a drawing depiction. The cumulative depiction of the product to be assembled can be at least one of a photographic depiction and a drawing depiction.

An exemplary embodiment of the present disclosure provides that the graphical depiction of a part of the product to be assembled is selectable to link to an order page enabling the assembler to submit an order for a predetermined quantity of the part of the product depicted in the graphical depiction.

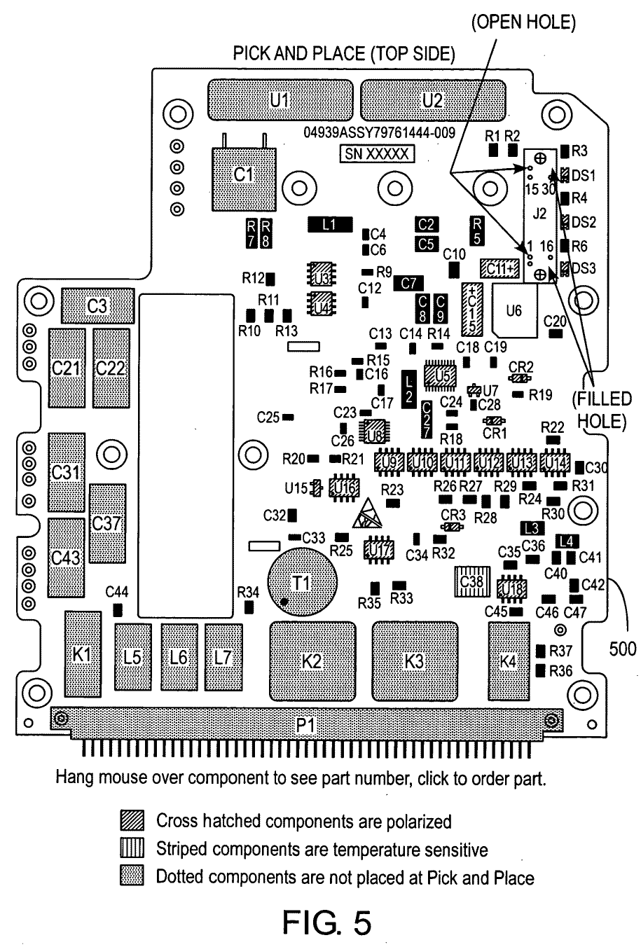

FIG. 5 is an illustrative example of an instruction superposed on an image 500 of a product to be assembled. The example of FIG. 5 illustrates the case where each instruction includes a cumulative depiction for each part of the product to be assembled. For clarity of illustration, textual depictions are not illustrated in FIG. 5. Each part denoted by one letter and a number (e.g., U1, U2) represents a graphical depiction of one of the cumulative instructions in assembling the product.

As denoted below the image 500 in FIG. 5, the assembler can operate an input device of the presentation apparatus (e.g., computer mouse, trackball, etc.) to hang (e.g., hover) over a part of the product represented by a graphical depiction of an instruction, and select the graphical depiction to link to an order page that enables the assembler to submit an order for a predetermined quantity of the part. For example, if the assembler selects the graphical depiction representing part “K2,” the assembler is linked to an order page in which he or she can order the part “K2.” The order page can be accessible through a public network such as the Internet, a LAN (local access network) of a group or entity, and/or a virtual private network (VPN). For example, in the case where the presentation apparatus is a computer, if the assembler selects part “K2,” the assembler can access an order page on which the part “K2” can be ordered. The order page can be managed internally in the case of a business where the assembler is operating the presentation apparatus at his or her place of business, or the order page can be managed externally by an entity that is separate from the assembler. As such, the presentation apparatus can be configured with communication functionality, such as the ability to connect to the Internet, a LAN or VPN.

The graphical depiction of the part of the product to be assembled is also selectable to link to a specifications page identifying technical specifications of the part of the product depicted in the graphical depiction. For example, as illustrated in FIG. 5, if the assembler selects part “K3,” the assembler can link to a specifications page that identifies technical specifications of the part “K3.” In addition, the technical specifications of the part of the product can identify at least one of one or more tools configured to assemble the part of the product, and safety precautions for assembling the part of the product. Similar to the above-described order page, the technical specifications page can an internal page managed by an entity with which the assembler has a relationship, such as the assembler's company, or the technical specifications page can be managed by an entity that is separate from the assembler. For example, either or both of the order page and the specifications page can be managed by a company that sold the product to be assembled to the assembler.

Another exemplary embodiment provides that the completion of each instruction is automatically saved in a memory communicatively coupled to the presentation apparatus upon receipt of the assembler instruction that the respective instruction was displayed. For example, the presentation apparatus can automatically save the completion of each instruction in an internal memory or removable memory inserted into a memory slot of the presentation apparatus, or the presentation apparatus can automatically save the completion of each instruction in a memory device that is remotely accessible to the presentation apparatus. The processor of the presentation apparatus can also generate a displayable index of each instruction completed on the presentation apparatus based on the instructions saved in the memory. The index, upon being displayed, enables the assembler to resume assembly of the product at an instruction immediately subsequent to the most recently completed instruction or at an already completed instruction by selecting the instruction immediately subsequent to the most recently completed instruction or the already completed instruction on the displayed index.

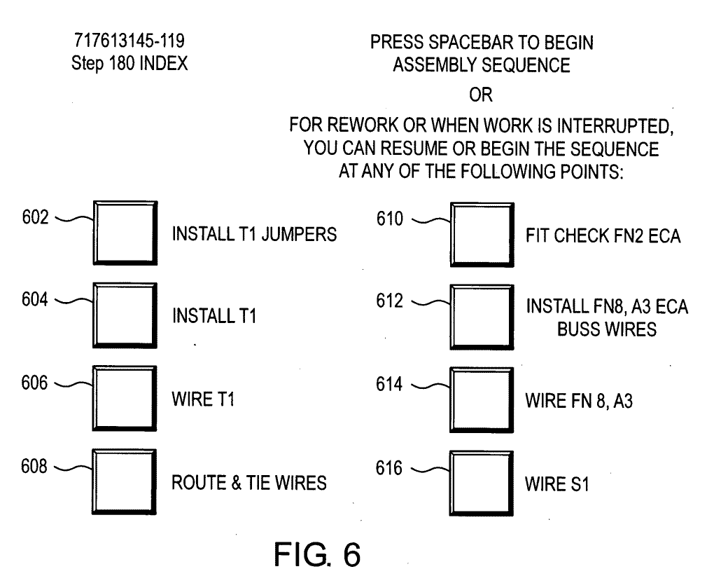

FIG. 6 is a representative example of a displayed index that is generated based on the automatic saving of each instruction completed by the assembler. Each selectable icon 602-616 illustrated in FIG. 6 represents an instruction that the assembler has previously completed. As such, if the assembler does not complete assembly of the product, the assembler can return to any instruction that was previously completed or start at the instruction following the instruction that was most recently completed.

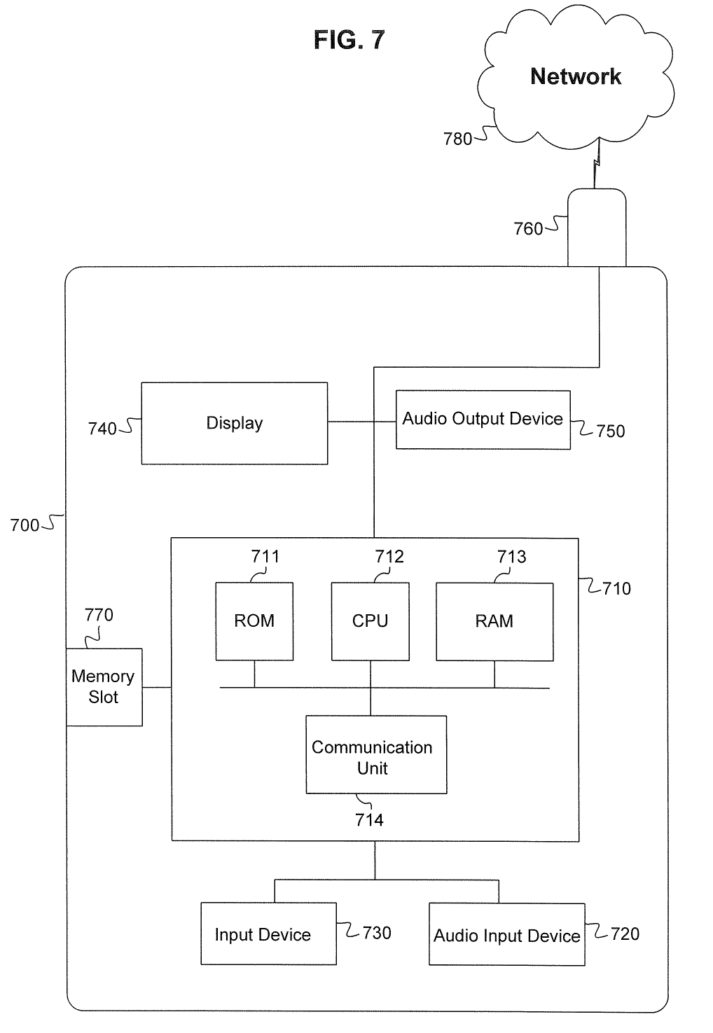

FIG. 7 is an explanatory diagram illustrating constituent elements of a presentation apparatus 700 according to an exemplary embodiment. As described above, a presentation apparatus can be a computer, such as a laptop, desktop, workstation, server computer or gaming computer, a personal digital assistant (PDA), a mobile telephone, a smartphone, a digital versatile disc (DVD) player, a high-definition DVD player (e.g., a Blu-ray player), etc., or any combination of these devices.

The exemplary presentation apparatus 700 can include a processing unit 710, an audio input device 720, an input unit 730, a display 740, an audio output device 750, a transmission/reception device 760, and a memory slot 770.

The processing unit 710 includes a ROM (read-only memory) 711), a RAM (random access memory) 712, a CPU (central processing unit), and a communication unit 714. The CPU 712 controls the aggregate functions of each component of the presentation apparatus 700 as well as the interrelationship and interaction between the other constituent elements of the presentation apparatus 700. The CPU 712 includes a processor for controlling the operations of the presentation apparatus 700. The ROM 711 stores programs, such as an operating system (OS) and application programs, and logic instructions which are implemented by the CPU 712. As described above, the completion of each instruction is automatically saved in a memory communicatively coupled to the presentation apparatus upon receipt of the assembler instruction that the respective instruction was displayed. Accordingly, the CPU 712 can cause each instruction completed by the assembler to be automatically stored in the ROM 711. The RAM 713 is used as a working memory by the CPU 712 when executing the programs and logic instructions stored in the ROM 711.

The audio input device 720 can receive audio inputs from the assembler of the product or other operator of the presentation apparatus. The audio inputs can be inputs to indicate that assembly of the product is to begin or that an instruction was completed. The audio input device 720 can include a microphone integrated with a sound card of the presentation apparatus 700, or an external microphone connected to the sound card of the presentation apparatus 700.

The input device 730 includes keys and pointing devices that can be manipulated by the assembler. For example, the input device 730 can include a QWERTY keyboard, a mouse, a trackball or similar selecting and pointing device, a number pad, a multi-input touch screen with a virtual keyboard and buttons represented in a graphical user interface or as a graphics tablet. Any input component of the input device 730 can be configured to receive inputs by the assembler to initiate the start of the assembly of a product or indicate completion of a displayed instruction in the assembly of the product. The assembler can designate a particular key or input button to receive the assembler inputs, or the assembler input key and/or button can be provided by design.

The display 740 is configured to display an image of a product to be assembled, and display a plurality of instructions for assembly of the product. As mentioned above, the input device 730 can include a multi-input touch screen with virtual keyboards and buttons and/or a graphics table. As such, the input device 730 and the display 740 can be an integrated component of the presentation apparatus 700. The display 740 can be integrated into the presentation apparatus 700, or an external component that is communicatively connected to the presentation apparatus 700.

The audio output device 750 can include a speaker for outputting audible instructions. The speaker can be integrated into the presentation apparatus 700 or be externally connected to the presentation apparatus 700. The transmission/reception device 760 enables the assembler to connect to a network 780 such as the Internet, a LAN or VPN to obtain an assembly presentation, access the above-described order page and/or specifications page, and connect to an external memory to save each completed instruction as described above. The transmission/reception device 760 is illustrated as extending from the main body of the presentation apparatus 700. For example, the transmission/reception device 760 can constitute a communication device for communicating wirelessly in the event that the presentation apparatus 700 is configured as a portable device. However, the transmission/reception device 760 can be integrated within the main body of the presentation apparatus 700 as an internal communication device. For example, the transmission/reception device 760 can be a modem and/or a network card to connect to an external network, LAN and/or VPN. Data received and transmitted by the transmission/reception device 760 is processed by the communication unit 714 of the processing unit 710, e.g., under the control of the CPU 712.

The memory slot 770 is configured to receive a removable memory (e.g., CD- or DVD-ROM, smartcard, flash memory) that is inserted therein. The memory slot 270 communicatively couples terminals of the removable memory card to the processing unit 710 to provide the components of the processing unit 710 access to data and programs stored on the memory card, and to store data thereon. For example, if an assembler purchases a product that requires assembly, an assembly presentation file or program according to the exemplary embodiments described herein can be stored on the memory that is sold with the unassembled product. The assembler can then access the file or program on the memory to begin assembly of the product.

The presentation apparatus can have a presentation program, such as Microsoft Power Point®, for example, installed thereon, and the assembler can use such a presentation program to present the assembly instructions according to the above-described exemplary embodiments.

The presentation apparatus therefore can access a computer program recorded on a computer-readable recording medium communicatively connected to the presentation apparatus for implementing the above-described exemplary embodiments.

Accordingly, an exemplary embodiment of the present disclosure provides a presentation apparatus 700 that comprises a display 740, a processor 710, and an input device 720, 730. The processor 710 can be configured to instruct the display 740 to display an image of a product to be assembled, and display a plurality of instructions for assembly of the product. The input device 720, 730 can be configured to receive an input indicating completion of an instruction displayed on the display, as well as an instruction to initiate or end assembly of the product.

The processor 710 can be configured to instruct the display 740 to display the image of the product, and superpose a first instruction for assembly of the product and instruct the display 714 to display the superposed first instruction on the displayed image of the product. In addition, the processor 710 can be configured to superpose a second instruction for assembly of the product and instruct the display to display the superposed second instruction on the displayed image of the product, upon the input device 720, 730 receiving an input indicating that the first instruction was completed. The exemplary presentation apparatus 700 can also be configured to perform the constituent functions of any of the above-described exemplary embodiments.

The present disclosure also encompasses a computer-readable recording medium having a computer program recorded thereon for causing a processor of the presentation apparatus communicatively connected to the computer-readable recording medium to perform the constituent functions of any of the above-described exemplary embodiments.

Combinations of the above-described exemplary embodiments, and other embodiments not specifically described herein will be apparent those skilled in the art upon reviewing the above description. The scope of the various exemplary embodiments includes various other applications in which the above structures, methods and programs may be used.

In addition, various aspects of the exemplary embodiments were described with reference to method steps and/or functions performed by structural components. It is to be understood that various aspects of the exemplary embodiments can also be performed by a computer program that is recorded on a computer-readable recording medium and causes a computing device to perform the various aspects of the exemplary embodiments, as appropriate.

It will be appreciated by those skilled in the art that the present disclosure can be embodied in other specific forms without departing from the spirit or essential character thereof. The presently disclosed embodiments are considered in all respects to be illustrative and not restrictive. The scope of the invention is indicated by the appended claims rather than the foregoing description, and all modifications that come within the meaning and range of equivalents thereof are to be embraced therein.

What is claimed is:

1. A method for assembly of a product, comprising:
displaying an image of a product to be assembled on a presentation apparatus;
superposing a first instruction for assembly of the product on the image of the product displayed on the presentation apparatus; and
superposing a second instruction for assembly of the product on the image of the product displayed on the presentation apparatus, upon receipt of an input to the presentation apparatus that the first instruction was completed.

2. The method of claim 1, comprising superposing a third instruction on the image of the product displayed on the presentation apparatus, upon receipt of an input to the presentation apparatus that the second instruction was completed.

3. The method of claim 1, wherein the image of the product displayed on the presentation apparatus is constituted by the same representation of the product for each instruction display.

4. The method of claim 1, wherein each instruction includes a graphical and textual depiction of a part of the product to be assembled in the respective instruction.

5. The method of claim 4, wherein the graphical and textual depictions are correlated to graphically illustrate the part of the product and provide textual instructions on assembling the part of the product.

6. The method of claim 4, wherein at least one of the instructions includes an audible instruction output from the presentation apparatus audibly explaining the respective instruction in the assembly of the product.

7. The method of claim 4, wherein the graphical depiction of the part of the product to be assembled is selectable to link to an order page enabling an assembler of the product to submit an order for a predetermined quantity of the part of the product depicted in the graphical depiction.

8. The method of claim 4, wherein the graphical depiction of the part of the product to be assembled is selectable to link to a specifications page identifying technical specifications of the part of the product depicted in the graphical depiction.

9. The method of claim 8, wherein the technical specifications of the part of the product identify at least one of one or more tools configured to assemble the part of the product, and safety precautions for assembling the part of the product.

10. The method of claim 1, wherein each instruction includes a cumulative depiction of the product to be assembled according to the respective instruction in the assembly of the product.

11. The method of claim 10, wherein the cumulative depiction of each instruction is at least one of a photographic depiction and a drawing depiction.

12. The method of claim 10, wherein the cumulative depiction of each instruction subsequent to the first instruction in the assembly of the product illustrates completion of each previous instruction in the assembly of the product.

13. The method of claim 1, wherein each instruction includes an animated depiction of how a part of the product is to be assembled in the respective instruction, and a textual instruction on assembling the part of the product.

14. The method of claim 1, wherein:
each instruction superposed on the image of the product is displayed on a display device comprised in or communicatively coupled to the presentation apparatus, and the input to the presentation apparatus is initiated by an assembler of the product to be assembled; and
the input includes at least one of a manual input to an input device of the presentation apparatus, and an audible input to an audio input device of the presentation apparatus.

15. The method of claim 1, wherein the presentation apparatus is one of a computer, a personal digital assistant (PDA), a mobile telephone, a smartphone, a television, and a digital versatile disc (DVD) player.

16. The method of claim 1, comprising removing an instruction superposed on the image of the product upon receipt of the input to the presentation apparatus to advance to an instruction immediately subsequent to the superposed instruction, and
wherein the removal of each instruction is initiated upon an assembler providing the input to the presentation apparatus to indicate that the superposed instruction was completed.

17. The method of claim 1, comprising:
automatically saving in a memory communicatively coupled to the presentation apparatus completion of each respective instruction upon the receipt of the input that the respective instruction was completed; and
generating a displayable index of each instruction completed on the presentation apparatus based on the instructions saved in the memory, wherein the index, upon being displayed, enables an assembler of the product to resume assembly of the product at an instruction immediately subsequent to the most recently completed instruction or at an already completed instruction by selecting the instruction immediately subsequent to the most recently completed instruction or the already completed instruction on the displayed index.

18. A computer-readable recording medium having a computer program recorded thereon for causing a processor of a presentation apparatus communicatively coupled to the computer-readable recording medium to perform operations comprising:
displaying an image of a product to be assembled on the presentation apparatus;
superposing a first instruction for assembly of the product on the image of the product displayed on the presentation apparatus; and
superposing a second instruction for assembly of the product on the image of the product displayed on the presentation apparatus, upon receipt of an input to the presentation apparatus that the first instruction was completed.

19. The computer-readable recording medium of claim 18, wherein the processor causes the presentation apparatus to superpose a third instruction on the image of the product displayed on the presentation apparatus, upon receipt of an input to the presentation apparatus that the second instruction was completed.

20. The computer-readable recording medium of claim 18, wherein the processor causes the presentation apparatus to display the image of the product so that the image of the product is constituted by the same representation of the product for each instruction display.

21. The computer-readable recording medium of claim 18, wherein each instruction includes a graphical and textual depiction of a part of the product to be assembled in the respective instruction.

22. The computer-readable recording medium of claim 21, wherein the processor causes the presentation apparatus to correlate the graphical and textual depictions superposed on the image of the product so as to illustrate the part of the product and provide textual instructions on assembling the part of the product.

23. The computer-readable recording medium of claim 21, wherein at least one of the instructions includes an audible instruction output from the presentation apparatus audibly explaining the respective instruction in the assembly of the product.

24. The computer-readable recording medium of claim 21, wherein the graphical depiction of the part of the product to be assembled is selectable to link to an order page enabling an assembler of the product to submit an order for a predetermined quantity of the part of the product depicted in the graphical depiction.

25. The computer-readable recording medium of claim 21, wherein the graphical depiction of the part of the product to be assembled is selectable to link to a specifications page identifying technical specifications of the part of the product depicted in the graphical depiction.

26. The computer-readable recording medium of claim 25, wherein the technical specifications of the part of the product identify at least one of one or more tools configured to assemble the part of the product, and safety precautions for assembling the part of the product.

27. The computer-readable recording medium of claim 18, wherein the processor causes the presentation apparatus to display each instruction as a cumulative depiction of the product to be assembled according to the respective instruction in the assembly of the product.

28. The computer-readable recording medium of claim 27, wherein the cumulative depiction of each instruction is at least one of a photographic depiction and a drawing depiction.

29. The computer-readable recording medium of claim 27, wherein the cumulative depiction of each instruction subsequent to the first instruction in the assembly of the product illustrates completion of each previous instruction in the assembly of the product.

30. The computer-readable recording medium of claim 18, wherein:
the computer-readable recording medium having the computer program recorded thereon is a portable recording medium configured to be inserted in a memory slot of the presentation apparatus; and
the presentation apparatus is one of a computer, a personal digital assistant (PDA), a mobile telephone, a smartphone, a television, and a digital versatile disc (DVD) player.

31. The computer-readable recording medium of claim 18, wherein each instruction includes an animated depiction of how a part of the product is to be assembled in the respective instruction, and a textual instruction on assembling the part of the product.

32. The computer-readable recording medium of claim 18, wherein:
the processor causes the presentation apparatus to display each instruction superposed on the image of the product on a display comprised in or communicatively coupled to the presentation apparatus, and the input to the presentation apparatus is initiated by an assembler of the product to be assembled; and
the input includes at least one of a manual input to an input device of the presentation apparatus, and an audible input to an audio input device of the presentation apparatus.

33. The computer-readable recording medium of claim 18, wherein:
the processor causes the presentation apparatus to remove an instruction superposed on the image of the product upon receipt of the input to the presentation apparatus to advance to an instruction immediately subsequent to the superposed instruction; and
the processor is initiated to cause the presentation apparatus to remove the superposed instruction upon an assembler providing the input to the presentation apparatus to indicate that the superposed instruction was completed.

34. The computer-readable recording medium of claim 18, wherein the processor causes the presentation apparatus to perform operations comprising:
automatically saving in a memory communicatively coupled to the presentation apparatus completion of each respective instruction upon the receipt of the input that the respective instruction was completed;
generating a displayable index of each instruction completed on the presentation apparatus based on the instructions saved in the memory; and
displaying the index to enable an assembler of the product to resume assembly of the product at an instruction immediately subsequent to the most recently completed instruction or an already completed instruction by selecting the instruction immediately subsequent to the most recently completed instruction or the already completed instruction on the displayed index.

35. A presentation apparatus comprising:
a display;
a processor configured to instruct the display to display an image of a product to be assembled, and display a plurality of instructions for assembly of the product;
an input device configured to receive an input indicating completion of an instruction displayed on the display,
wherein the processor is configured to:
instruct the display to display the image of the product;
superpose a first instruction for assembly of the product and instruct the display to display the superposed first instruction on the displayed image of the product; and
superpose a second instruction for assembly of the product and instruct the display to display the superposed second instruction on the displayed image of the product, upon the input device receiving an input indicating that the first instruction was completed.
